(19) United States
(12) Patent Application Publication
(10) Pub. No.: US 2021/0298122 A1
(43) Pub. Date: Sep. 23, 2021

(54) Wireless Water Restoration System

(71) Applicant: Konrad Kukowski, Chicago, IL (US)

(72) Inventor: Konrad Kukowski, Chicago, IL (US)

(21) Appl. No.: 16/825,568

(22) Filed: Mar. 20, 2020

(51) Int. Cl. H04W 84/18; H04W 24/10; G01N 27/22; G01K 7/00; H04L 29/06; G06F 3/0482; B64C 39/02

(52) U.S. Cl. CPC H04W 84/18; H04W 24/10; G01N 27/223; B64C 2201/123; H04L 63/083; G06F 3/0482; B64C 39/024; G01K 7/00

(57) ABSTRACT

The present application discloses a system which may be used for remotely monitoring and collecting information about a work site, such as a site which has suffered water damage or which must be remediated for moisture. The discloses system includes a centralized server and nodes, wherein the nodes may be affixed to physical positions at the site. The disclosure includes nodes which have a moisture sensor, and other sensors, for relaying information back to the server. The server may also connect to and be controlled from a remote interface. The disclosed system may present users with a virtual map overlaid with readings from a sensor, wherein the virtual map may correspond to the blueprint of a work site or building being remediated. In some circumstances, a drone may be used for creating the virtual map. This disclosure is also directed to various reporting functionality for presenting users with moisture readings.

### FIELD OF THE INVENTIONS

The present inventions relate to equipment used for surveying, containing, and remediating water damage as quickly and effectively as possible.

### BACKGROUND OF THE INVENTIONS

It is important to contain and remediate water damage to a building as soon as possible. Often times, a water restoration technician is assigned to assess the loss, and to be responsible for drying the building. The water restoration technician may use a moisture meter, thermometer, and/or humidity meter to take measurements of the damages building. Typically, these measurements would be taken on a daily basis, and recorded, until the building is determined to be dry. The water restoration technician may use the reading to determine the type (and number) of equipment needed for drying the structure. Moreover, the collected information may be submitted to insurance companies, where appropriate.

The current and prior art devices and methods require a water restoration technician to take readings manually. Readings are often written by hand, which makes them prone to errors or inaccuracies. For example, a technician may estimate readings, record imprecise readings, record erroneous readings, record readings in poor hand writing, etc. Moreover, such readings are often later recorded into a computer, which increases time requirements (and labor costs). Similarly, technicians may keep hand-written logs of materials, labor costs, and equipment used at each job site. These logs are likewise prone to the above mentioned inaccuracies.

Additional disadvantages of manual readings include the fact that the damaged area may not be easily accessible. For example, where water damage affects a hard to reach part of a building (for example, a high ceiling or dome, etc.), a technician may have difficult reaching the affected area on a daily basis.

### BRIEF SUMMARY OF THE INVENTIONS

In view of the foregoing, it would be advantageous to automate the collection of environmental readings (including, without limitation, readings of moisture, humidity and temperature) so as to reduce the time a technician spends collecting and recording the readings, and entering them into a computer system. It would be advantageous for a technician to be able to monitor the various readings from any location, for example, via an internet connection. Accordingly, technicians would not have to access hard to reach areas on a daily basis, but rather, must only access the areas to install appropriate sensors or analyzers, and again to uninstall them upon completion.

Additionally, it would be advantageous to record and document additional information about a job site, including the materials use to remediate the damage, logs of labor costs, equipment logs, scheduling, and archives showing photographs of a job site. It would further be advantageous to provide a color-coded map, rendering, or blue print of a job site, where the coded colors are indicative of damaged areas, and/or their status.

Further yet, it would be advantageous to provide a technician with a system for instantly view recorded information, including (without limitation) past and current readings, and for compiling all the stored data and information in one system. Moreover, it would be advantageous for such stored data and information to be easily converted into a comprehensive report used, among other things, for insurance reimbursement.

### DESCRIPTIONS OF THE FIGURES

FIG. 1 shows an exemplary blueprint of an area to be remediated for water damage, or related damage

FIG. 2 shows a stack diagram of exemplary components of a node.

FIG. 3 shows a schematic diagram of exemplary components of a node, together with the connections between them.

FIG. 4 shows a stack diagram of exemplary components of a controller.

FIG. 5 shows a schematic diagram of exemplary components of a controller, together with the connections between them.

FIG. 6 shows a system of nodes connected to a master controller, and in turn connected to one or more servers.

FIG. 7 shows a system of nodes connected to a plurality of controllers, respectively, and further connected to one or more servers.

FIG. 8 shows a dedicated generic attribute profile (GATT).

### DETAILED DESCRIPTION OF THE PREFERRED EMBODIMENTS

The present inventions are directed to apparatuses and methods for use in connection with property damage, including, without limitation, water damaged buildings. Aspects of the inventions include the automatic collection of moisture, humidity, and temperature readings, and functionality for creating reports based on the collected information.

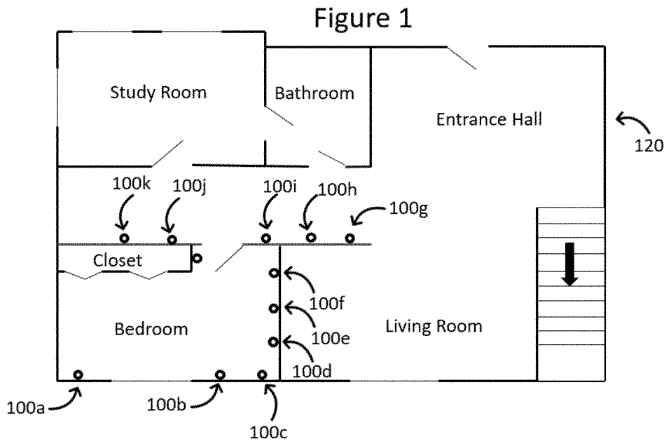

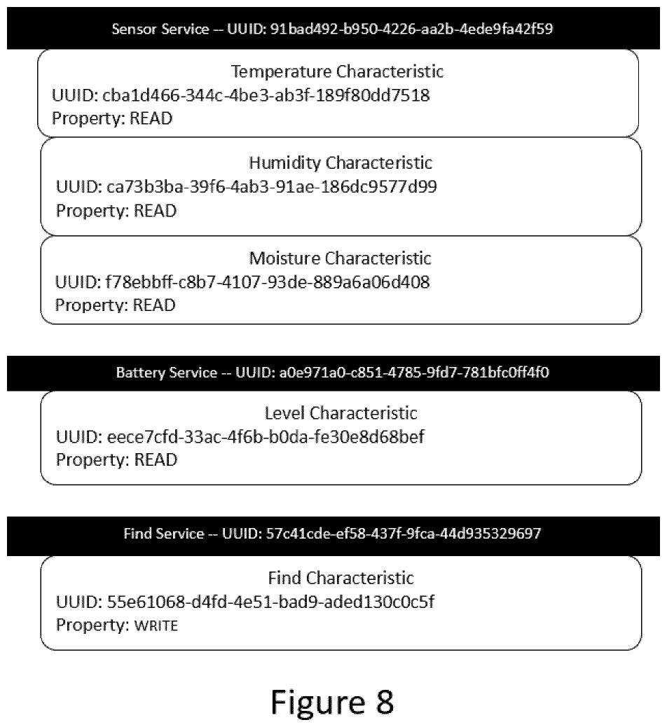

Aspects of the inventions are embodied in hardware and software. Exemplary hardware components include one or more analyzer nodes 200, controller 400s, and/or server 500s. It should be understood that an analyzer node 200 is a hardware component comprising sensors for sensing moisture, humidity, temperature, etc., and for communicating such information to a controller 400 and/or server 500. Analyzer node(s) 200 may be spaced apart and positioned within an area to be remediated for water or moisture damage. For example, FIG. 1 illustrates a blueprint of a structure 120 with various nodes 100a-k positioned throughout rooms of the structure 120. As will become apparent from the following disclosure, such nodes 100a-k may communicate with other components of the system of the present invention. Between the analyzer node 200, controller 400, and/or server 500 may take the form of known wired transmissions, wireless transmissions (including Wi-Fi and/or Bluetooth). In some embodiments, the one or more nodes may communicate via low power wireless communication protocols, such as Bluetooth Low Energy. Nodes may rely on a dedicated GATT profile as shown in FIG. 8.

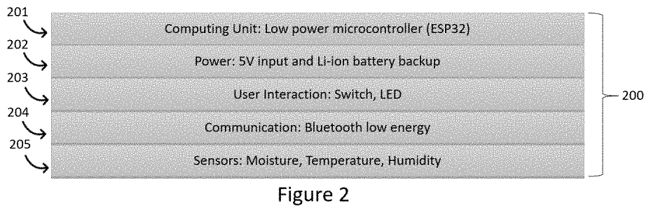

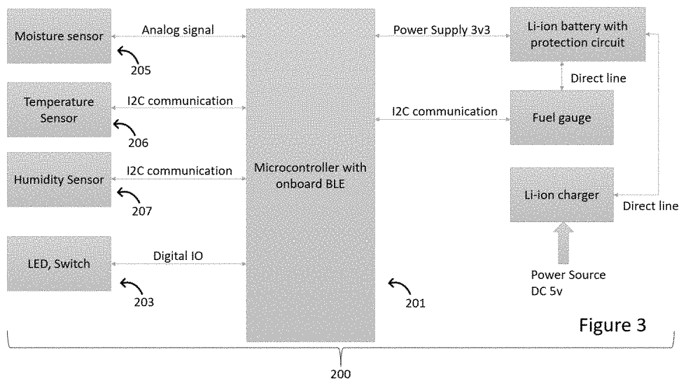

In embodiments of the inventions, the analyzer node(s) 200 may be a separate, always-on device which communicates via Bluetooth Low Energy. An exemplary stack diagram of a analyzer node 200 is shown in FIG. 2. For example, FIG. 2 illustrates a microprocessor 201, a power supply (battery) 202, a user interface 203 such as a switch and/or LED screen, a communication module 204, and a variety of sensors 205. The illustrated sensors may include moisture, temperature, humidity, and other sensors. FIG. 3 illustrates exemplary connections between such components. For example, it can be seen that sensors 206, 207 connect to microprocessor 201 via I2C communication lines. Moisture sensor 205 is shown to have an exemplary analog signal connection to microprocessor 201. A person of ordinary skill in the art, having the benefit of the present disclosure, would recognize that other communication lines may also be used.

As is apparent from the present disclosure, once an analyzer node 200 has been positioned within a remediation location, it may communicate readings to a controller 400. Communications may include sensor readings relating to moisture, humidity, and temperature, in other words, measurements taken by sensors 205-207 of the analyzer node 200. Embodiments of the analyzer node 200 may include sensors, where some sensors may be discrete components whereas other sensors may be IC base. The node may further include a chip, such as a microprocessor 201 for collecting information from sensors, processing, and communication such information wirelessly. It is contemplated that an ESP32 SoC chip with onboard Bluetooth classic and Bluetooth Low Energy (BLE) may be used in certain embodiments of the inventions. A Li-ion battery (e.g. power supply 202) supporting deep sleep mode may be used to provide power. Such embodiments may have the advantage of providing efficient power usage, a low foot print, and a relatively lower cost to manufacture and operate. Charging cradles may be provided. For example, some embodiments may include wireless charging cradles, or external charging cables. Moreover, some cradles may include multiple slots for charging multiple devices simultaneously, for example, embodiments may include 5, 10, 15, or 20 slots.

Each analyzer 200 is equipped with, at least, a moisture sensor 205. The moisture sensor 205 may be the type using pins or waves. Additionally, a temperature sensor 206 and humidity sensor 207 may be provided also. An analyzer 200 may be wall mounted and have two pins for measuring moisture in the wall/on the surface of the wall. In other embodiments, analyzer 200s may include two cables which connect to provided ports. The other end of such cabled may connect to two pins which are used to determine the moisture.

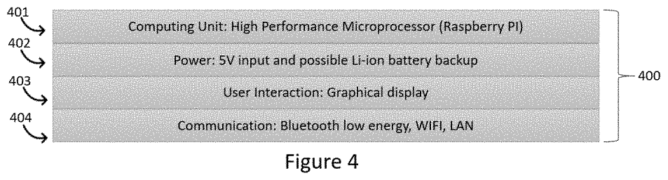

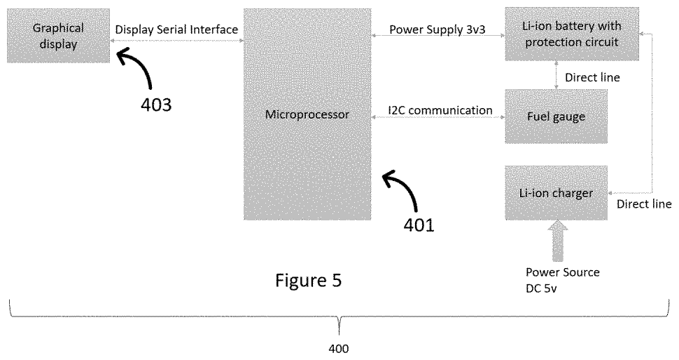

Turning now to the controller 400, it is contemplated that embodiments may provide a device capable of handling multiple communication requests from the nodes, including communication requests using Bluetooth Low Energy. The controller 400 may take the form of any known computing device. In some embodiments, the controller 400 takes the form of a tablet-style device having a touch screen and keyboard, and cellular communication capabilities. FIG. 4 shows a stack diagram of the functionality of controller 400, and FIG. 5 shows a schematic showing exemplary components of controller 400.

As is illustrated, the controller 400 may also comprise a battery 402 for powering the device 400. The battery may be rechargeable. The controller 400 may also have a storage device, such as, a minimum of 25 GB of hard drive space, and a minimum of 4 GM RAM. The controller 400 may further comprise its own microprocessor 401 and a user interface, such as a graphical display 403, which may be a touch screen or any other known user interface. In some embodiments of the inventions, the microprocessor 401 of the controller 400 may be a Raspberry Pi. It supports the attachment of an external battery capable of supplying 5V and at least 2 amps of current. The controller 400 is further configured to run a wireless communication protocol, which may be any protocol known in the art. One example of a well-suited protocol is Bluetooth Low Energy. The controller 400 may further include hardware 404 for cellular communication capabilities, such as internet connections for communication with one or more server 500s. As described further herein, the controller 400 may be configured to release some or all of the collected raw data to a server 500 once a connection with the server 500 has been made.

The controller 400 may be configured to execute a computer program configured to create a new project, edit existing project, mark a project as completed, display, on the display, data collected and received from the analyzer 200s. The computer program may also display additional information, such as the battery life of the device itself, as well as the battery life of each of the analyzer 200s connected to the controller 400 (for example, analyzer 200s connected to the controller 400 by Bluetooth using GATT profile FIG. 8 or any other protocol). Upon initializing the controller 400 for the first time, users may be prompted to configure the date and time, while creating a project or syncing to an existing project on the server 500. The date and time may later be used in connection with collected data, i.e., to indicate the data and time at which various data is collected.

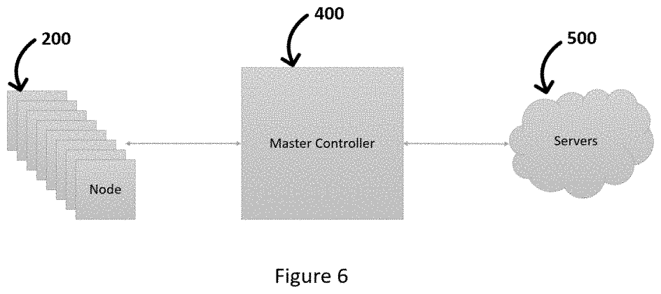

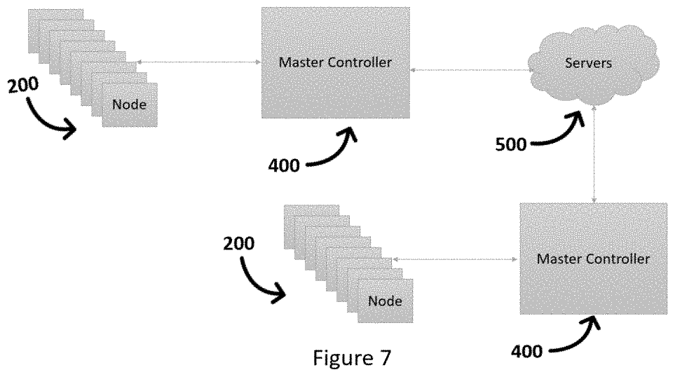

The inventions include systems in which controllers 400, analyzers 200 (or groups of analyzer 200s) and one or more server 500s interact with one another to collect, analyze and present data. FIGS. 6 and 7 show exemplary diagrams of nodes 200 communicating with master controllers 400 and servers 500. In particular, FIG. 6 shows an embodiment of a system in which a plurality of nodes 200 connect to a single master controller 400, which in turn connects to server(s) 500. An alternative embodiment is seen in FIG. 7, wherein a plurality of nodes 200 connect (respectively) to a first or second master controller 400, and the first and second master controllers in turn connect to the server(s) 500. Based on the present disclosure, it should be understood that both system configurations are possible and compatible with the inventions disclosed herein.

Having established a connection between the components, the individual analyzers 200 measure moisture and transmit collected measurements to a controller 400 (or, to multiple controllers 400 as seen in the embodiment of FIG. 7). The analyzer 200(s) pair with the controller 400 to make such transmission. Pairing may be initiated by activating a button on the analyzer 200. The controller 400 may enter a listening mode to facilitate pairing. Further, the controller 400 may include a visual indicator which indicates the nature or status of the connection to a user, for example, using various lights or colors. The controller 400 allows visual light indicator configuration. In such embodiments, users specify the color of the LED light on the analyzer 200s, from the paired controller 400. This allows the user to visually identify which analyzer 200 is connected to which controller 400 (especially in a scenario where multiple controller 400s and multiple analyzer 200s are used in the same project).

In some embodiments, analyzers 200 may act as relays to pass information to the controller 400. Such a configuration extends the range of the system. In some embodiments, analyzer s 200 should be paired with the controller 400 prior to the analyzer 200 being deployed on a projection.

The analyzer 200 may have a serial number which is associated with the controller 400, project, physical location/wall provided by the user. Each serial number is preferably unique. After configuration is completed, the data collection process begins. Adding, suspending, moving, and removing analyzer 200s from the controller 400 is possible at any time. Each analyzer 200 may pair with one or more controller 400s. In order to prevent mixing or confusing data streams, any additional controller 400s must not be in range of the analyzer 200 that is paired with another controller 400. The controller 400 may store the analyzer 200's information for faster reconnection.

The controller 400 organizes and stores the data in a database. The database associates the collected measurements with the name of the analyzer 200 collecting said data, and may optionally provide a visual representation of such data. Further, the controller 400 may be configured to recognize the physical location of each connected analyzer 200. For example, the controller 400 may be configured to recognize that an analyzer 200 is mounted on a given wall, room, or any other location.

In embodiments of the inventions, the controller 400 and the analyzer 200 may be in continuous contact, or communications may occur at regular intervals. Exemplary intervals include 60 seconds, 5 minutes, 30 minutes, 1 hour, 12 hours, and/or 24 hours. The frequency of communications may be user-adjustable. It should be understood that in some scenarios, relatively frequent communication may be desirable. In other scenarios, less frequent communication may be needed and thus battery can be saved by selecting longer time intervals.

Optionally, the controller 400 may connect to a server 500. In embodiments where no server 500 is used, the controller 400 may create a local account, which may be protected by a username and password.

In other embodiments, the controller 400 may establish an internet connection for communication with the server 500. Establishing a connection may require authentication, including optional username and password. Such credentials may be cached by the controller 400 for subsequent offline use. The server 500 may be Linux or Windows-based, running custom management software. The server 500 also includes a database, which in turn stores information about each subscriber and data collected or entered. The server 500 will have different types of accounts, such as: an administrator and standard user. The administrator will have the additional capabilities to reset password for all the users. Importantly the server 500 provides a live view for the project manager and insurance adjuster. There are two options offered, an onsite and offsite solutions.

The server 500 may be hosted locally, in the cloud, or in any other environment. It will be understood that subscribers using their own hardware would be responsible for providing and maintaining the server 500. Database can be hosted on any database solutions including but not limited to MySQL or IBM DB2. Software patches and maintenance is covered in a lowered subscription cost, on top of the purchase of the software. In embodiments where a subscriber chooses a hosted solution, such subscriber may pay a monthly fee for hosting, maintaining and licensing the server 500. Subscribers will have their own separate database. Disaster recovery, all patches and upgrades are included in the subscription.

Upon establishing such a connection between the controller 400 and the server 500, the controller 400 begins to release some, or all, of the collected data to the server 500. If no connection is established between the controller 400 and the server 500, the controller 400 continues to store received information in its memory, until such memory is full. The controller 400 may continue transmitting information to the server 500 once a connection is established, or re-established, as the case may be. The controller 400's computer application may present a user option for deleting raw data once it is transmitted to the server 500, or once the project is complete. In some embodiments, to prevent accidental or unauthorized deletion of data, the computer application may require that a project be marked as “completed” before data may be deleted. In this sense, some embodiments of the inventions may safe guard against the accidental deletion of data.

The server 500, in turn, may provide a web application for users to receive and view a live stream of the transmitted moisture data, and any other data recorded or associated with it. Embodiments of the web application may provide visualization of organized data, including an interface that displays the location, the location's owner or responsible party, the nature of the project, the date of the project, and the data and measurement of the respective moisture readings. An exemplary web interface shows status readings and serial numbers for connected analyzer nodes 200 (and their respective sensors). Moisture readings may also be presented in a time serious, or as a visual graph that represents the moisture reading as a function of time. The web application may be further configured to present such data in report form which can be exported to another format, or printed on a connected printer.

The server 500's web application may further be configured to export the data to PDF, CSV, XML and XLSX formats. The reports generated by the server 500 provide a clear representation of the restoration. The reports filed with the insurance claim provides a clear justification of billed equipment, materials and labor. Functionality may include:
1) “Full report”—Provides all the data collected for the selected projects. The user has the option to include a graph, by specifying the period the graph should represent. All readings are included temperature, moisture and humidity. As well as materials, equipment and personnel used to complete the job.
2) “Partial report”—Provides day averages and the graph to represent the data. All readings are included temperature, moisture and humidity.
3) Custom report—User specified data is provided in the report. The custom report has the capabilities to be saved as a templet for future one-click exports.

The web application may be configured to further present functionality and an interface for adding, suspending, or removing analyzer 200s connected to the controller 400. Additional screens on the interface may allow users to see opened and closed projects, the status of projects, create new projects, and connect or disconnect from the server 500.

Upon initial log in, no projects exist yet. The user may be prompted by the application's interface to “create a new project.” This may be done on the controller 400 or on the server 500's web application. The user is prompted to type in project name/number and frequency of data collection, which may be required before proceeding. The other optional fields are: project address, clients contact information. On the controller 400 the user must select from a list, which paired analyzer 200s they would use for the project. There is also an option to pair an analyzer 200 that is not on the list. Finally, the user can identify the location of each analyzer 200 on the controller 400 or on the server 500 application's interface. For example, analyzer 200 23452AF34—Bedroom east wall. If the controller 400 is connected to the server 500, all the setup information will be synced to the server 500.

After setting up the controller 400 and/or the Server 500, analyzer 200s should be placed in the appropriate physical location. It must be placed in a location that is within range of the controller 400, or, where analyzer 200s are chained together, each analyzer 200 must at least be in range of another analyzer 200, where at least one analyzer 200 in turn connects to the controller 400.

Any time during the collection process, the user can monitor the data coming in. The user can also change the frequency of data collection, and the color of the analyzer 200s. The user can also identify which analyzer 200 matches with the description in the record. If an analyzer 200 is placed in the wrong location, the user can click locate icon on the controller 400's project screen. This will make the light blink on the selected analyzer 200. Showing the user which analyzer 200 is associated with which given description. When the controller 400 and the analyzer 200s are needed at a different project. The user would close or pauses the current project, closing the project will prohibit further data collection. Pausing allows the user to resume the data collection at a different time, while still being able to collect data from a different project in the meantime.

Embodiments of the inventions can be used in connection with remediation projects of all sizes. For larger projects, a self-flying drone having a camera may be provided for measuring and mapping the area to be monitored. For example, the drone may create a map of the area, and such map may be uploaded to the server 500. The map may then be displayed on the web application's interface. Such embodiments allow users to visualize the entire area, and the web application's interface may additional create a visual overlay showing where on the map the analyzer 200s are located. For example, the blueprint 120 of FIG. 1 may be displayed on a screen, with the location of nodes 100a-k virtually overlaid onto the blueprint 120. Users are thus provided with a visualization of the entire area, with measurements from the analyzer 200 overlaid on the map.

The drone may also take photographs of the entire area, or portions of the area, and upload such photographs to the server 500. The web application may then overlay the photographs over a virtual or interactive map, thereby providing the benefit of showing photographs of affected areas. The drone may also be programmed to survey the area on a periodic basis, and provide photographs showing progress made. Picture documentation of the area, and thermal images thereof, may be provided as a 3-D model of the area. The server 500 may be configurated to import and export such files in CAD format.

Additional functionality may include an application, such as for a smart phone or tablet device, which uses augmented reality to allow a user to see the damages areas, optionally combined with the most recent measurement from the analyzer 200s. Such augmented reality application may use the camera of a smart phone or tablet, or any other known hardware for augmented reality. As a non-limiting example, a user may point their phone (with the camera on) at a given wall. The phone screen will display the camera image of the wall, while also showing an overlay that visualizes the thermal image and current moisture readings. As the user moves throughout an affected area, the display changes (like a video) showing the thermal and data overlay of the surface that is captured by the camera lens.

What is claimed is:

1. A system for monitoring remediation of water damage, comprising:
a plurality of analyzer nodes, each analyzer node comprising at least a processing unit, a power supply, a user interface, a wireless communication unit, and a plurality of sensors;
at least one controller, the controller comprising a controller processing unit, a controller power supply, a controller wireless communication unit, and a controller user interface; and
a server comprising a server wireless communication unit;
wherein the plurality of analyzer nodes is in wireless communication with the at least one controller, and the at least one controller is in wireless communication with the server.

2. The system of claim 1, wherein the plurality of analyzer nodes has a plurality of sensors which comprise at least a moisture sensor, a temperature sensor, and a humidity sensor.

3. The system of claim 2, wherein the plurality of analyzer nodes is positioned in a spaced-apart configuration at a site to be remediated.

4. The system of claim 3, wherein each of the plurality of analyzer nodes has a unique serial number associated with said analyzer node.

5. The system of claim 4, wherein the plurality of analyzer nodes is configured to wirelessly communicate a reading from the moisture sensor, the temperature sensor, and the humidity sensor to the controller.

6. The system of claim 5, wherein the server further comprises a database; wherein the controller further communicates said readings from the moisture sensor, the temperature sensor, and the humidity sensor to the server; and the server associates said readings with the unique serial number associated with said analyzer node.

7. The system of claim 6, wherein the server further comprises an application, and the application is configured to receive a username and password for authentication.

8. The system of claim 7, wherein the application is further configured to present a user interface for adding, suspending, or removing one or more analyzer nodes.

9. The system of claim 8, wherein the application is further configured to present a user interface for presenting open and closed projects, creating new projects, and viewing the status of projects.

10. The system of claim 9, wherein the web application is further configured to present a blueprint of the site to be remediated.

11. The system of claim 10, further comprising a self-flying drone having a camera, and the self-flying drone is configured to map the site to be remediate.

12. The system of claim 11, wherein the self-flying drone's map of the site to be remediated is uploaded to the server and displayed on a user interface.

13. The system of claim 8, wherein the application is further configured to generate reports based on the data collected.
